(19) United States
(12) Patent Application Publication
(10) Pub. No.: US 2016/0167426 A1
(43) Pub. Date: Jun. 16, 2016

(54) APPARATUS FOR VEHICLE WHEEL RIM

(71) Applicants: Roy EDWARDS, New Westminster (CA); Karen EDWARDS, New Westminster (CA)

(72) Inventors: Roy EDWARDS, New Westminster (CA); Karen EDWARDS, New Westminster (CA)

(21) Appl. No.: 14/570,828

(22) Filed: Dec. 15, 2014

(51) Int. Cl. B60B 7/10; B60B 7/02; B60B 7/00

(52) U.S. Cl. CPC B60B 7/10; B60B 7/0053; B60B 7/02; B60B 2320/50

(57) ABSTRACT

Apparatus is for vehicle wheel rim having outer peripheral rim edge surrounding an outer-facing zone. Vehicle wheel rim is configured to provide a connection with vehicle tire of vehicle. Apparatus includes rim-cover assembly having outer peripheral edge. Rim-cover assembly is configured to cover, at least in part, outer-facing zone of vehicle wheel rim for case where rim-cover assembly is positioned relative to outer-facing zone of vehicle wheel rim. Resilient clips are each positionable at spaced-apart positions located on outer peripheral edge of rim-cover assembly. Resilient clips are configured to resiliently clip the outer peripheral edge of rim-cover assembly at spaced-apart positions to outer peripheral rim edge, for case where rim-cover assembly is positioned relative to outer-facing zone of vehicle wheel rim.

### TECHNICAL FIELD

Aspects generally relate to an apparatus for a vehicle wheel rim configured to provide a connection with a vehicle tire of a vehicle.

### BACKGROUND

Vehicles include a set of vehicle wheel rims. The vehicle wheel rim provides a connection between a vehicle wheel and a vehicle tire, either permanently attached to or removable from the vehicle wheel. The vehicle wheel rim provides a circular strip of metal forming the connection. The vehicle wheel rim is where the vehicle tire securely resides on the vehicle wheel, and the vehicle wheel rim supports the tire shape. The vehicle wheel rim makes up the outer circular design of the vehicle wheel on which the inside edge of the vehicle tire is mounted.

### SUMMARY

It will be appreciated that there exists a need to mitigate (at least in part) at least one problem associated with vehicle wheel rims. After much study of the known systems and methods with experimentation, an understanding of the problem and its solution has been identified and is articulated as follows:

To mitigate, at least in part, at least one problem associated with vehicle wheel rims, there is provided (in accordance with a major aspect) an apparatus. The apparatus is for a vehicle wheel rim having a peripheral rim edge surrounding an outer-facing zone. The vehicle wheel rim is configured to provide a connection with a vehicle tire of a vehicle. The apparatus includes a rim-cover assembly having an outer peripheral edge. The rim-cover assembly is configured (dimensioned) to cover, at least in part, the outer-facing zone of the vehicle wheel rim for the case where the rim-cover assembly is positioned relative to the outer-facing zone of the vehicle wheel rim to do just so. Resilient clips are each positionable at spaced-apart positions that are located on the outer peripheral edge of the rim-cover assembly. The resilient clips are each configured to resiliently clip the outer peripheral edge of the rim-cover assembly at the spaced-apart positions to the peripheral rim edge of the vehicle wheel rim, for the case where the rim-cover assembly is positioned relative to the outer-facing zone of the vehicle wheel rim just so.

To mitigate, at least in part, at least one problem associated with vehicle wheel rims, there is provided (in accordance with a major aspect) an apparatus. The apparatus is for a vehicle wheel rim having a peripheral rim edge surrounding an outer-facing zone. The vehicle wheel rim is configured to provide a connection with a vehicle tire of a vehicle. The apparatus includes a combination of a rim-cover assembly, a rod assembly, and resilient clips. The rim-cover assembly has a peripheral sleeve extending around the rim-cover assembly. The rim-cover assembly is configured (dimensioned) to cover, at least in part, the outer-facing zone of the vehicle wheel rim. This is done for the case where the rim-cover assembly is positioned relative to the outer-facing zone of the vehicle wheel rim (to do just so). The rod assembly is configured to be received, at least in part, in the peripheral sleeve of the rim-cover assembly. The resilient clips are each positionable at spaced-apart positions being located on the peripheral sleeve of the rim-cover assembly. The resilient clips are each configured to resiliently clip the rod assembly at the spaced-apart positions to the peripheral rim edge of the vehicle wheel rim. This is done for the case where the rod assembly is received in the peripheral sleeve and where the rim-cover assembly is positioned relative to the outer-facing zone of the vehicle wheel rim just so.

Other aspects are identified in the claims.

Other aspects and features of the non-limiting embodiments may now become apparent to those skilled in the art upon review of the following detailed description of the non-limiting embodiments with the accompanying drawings.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIGS. 1A, 1B, 1C and 1D (SHEETS 1 AND 2 OF 11 SHEETS) depict views of embodiments of an apparatus for a vehicle wheel rim configured to provide a connection with a vehicle tire of a vehicle;

FIG. 2 (SHEET 3 OF 11 SHEETS) depicts a view of an embodiment of an apparatus of any one of FIGS. 1A, 1B, 1C and 1D;

FIGS. 3A, 3B and 3C (SHEET 4 OF 11 SHEETS) depict views of embodiments of an apparatus of any one of FIGS. 1A, 1B, 1C and 1D;

FIG. 4 (SHEET 5 OF 11 SHEETS) depicts a view of an embodiment of an apparatus of any one of FIGS. 1A, 1B, 1C and 1D;

FIGS. 5A and 5B (SHEETS 6 AND 7 OF 11 SHEETS) depict views of embodiments of an apparatus of any one of FIGS. 1A, 1B, 1C and 1D;

FIGS. 6A and 6B (SHEET 8 OF 11 SHEETS) depict views of embodiments of an apparatus of any one of FIGS. 1A, 1B, 1C and 1D;

FIG. 7 (SHEET 9 OF 11 SHEETS) depicts a view of an embodiment of an apparatus of any one of FIGS. 1A, 1B, 1C and 1D;

FIG. 8 (SHEET 10 OF 11 SHEETS) depicts a view of an embodiment of an apparatus of any one of FIGS. 1A, 1B, 1C and 1D; and

FIG. 9 (SHEET 11 OF 11 SHEETS) depicts a view of an embodiment of an apparatus of any one of FIGS. 1A, 1B, 1C and 1D.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted.

Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

100 apparatus
102 rim-cover assembly
103 outer peripheral edge
104 peripheral sleeve
106 elongated rod assembly
107 elongated rod portions
108 resilient clips
110 sewing line
112 first clip zone
114 second clip zone
116 inner rod
118 outer layer
120 eyelets
900 vehicle wheel rim
902 outer peripheral rim edge
904 outer-facing zone
906 vehicle tire
908 vehicle
910 car
912 commercial trailer

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the invention is defined by the claims. For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described.

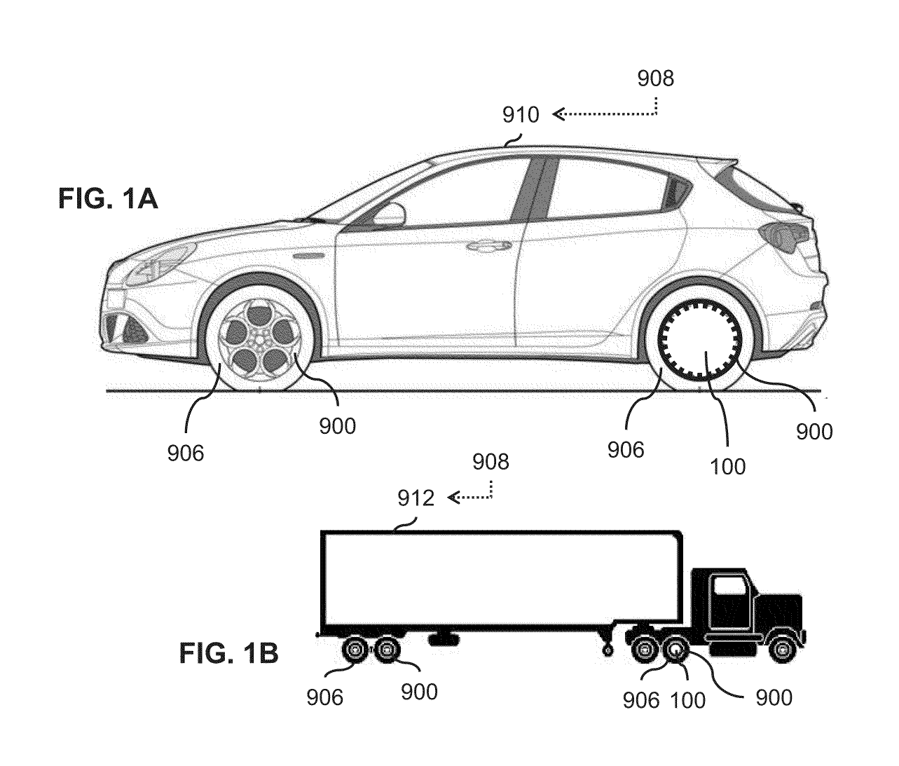

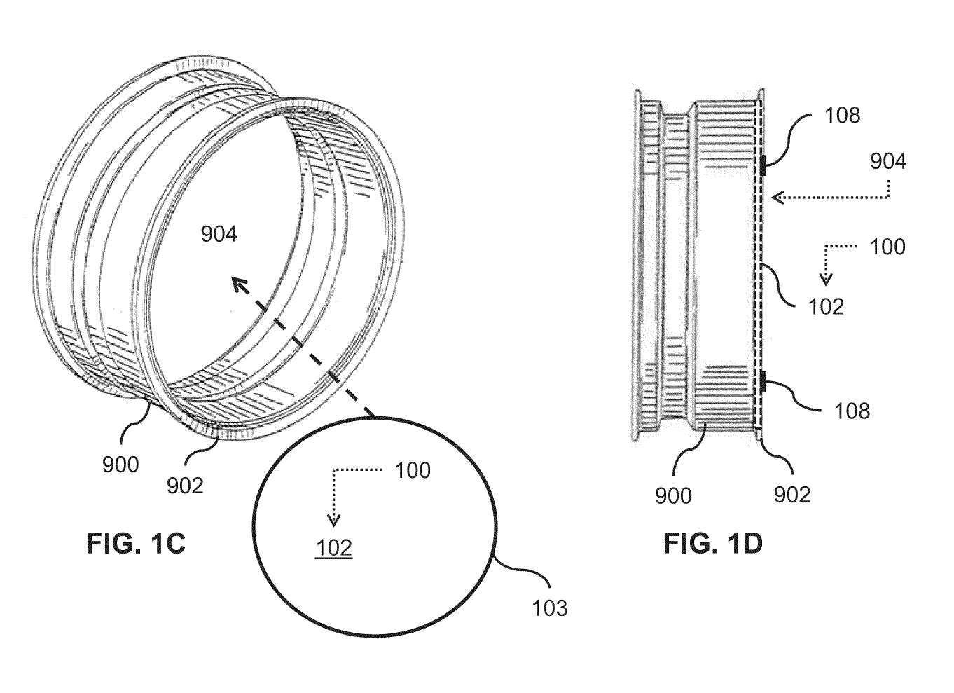

FIGS. 1A, 1B, 1C and 1D depict views of embodiments of an apparatus 100 for a vehicle wheel rim 900 (and any equivalent thereof). The vehicle wheel rim 900 is configured to provide a connection with a vehicle tire 906 of a vehicle 908 (and any equivalent thereof). FIGS. 1A and 1B depict side views. FIG. 1C depicts a perspective view. FIG. 1D depicts a side view.

For instance, the vehicle wheel rim 900 has an outer peripheral rim edge 902 surrounding an outer-facing zone 904. The vehicle wheel rim 900 is configured to provide a connection with the vehicle tire 906 of the vehicle 908. The apparatus 100 is configured to selectively attach to, and is also configured to selectively detach from, the vehicle wheel rim 900. Each instance of the vehicle wheel rim 900 may have a respective instance of the apparatus 100.

For the case where the apparatus 100 is not used (that is, not operatively mounted to the vehicle wheel rim 900), passing air may enter into an internal rim cavity formed by the vehicle wheel rim 900 (while the vehicle 908 is moving). For this case, the air that enters the internal rim cavity imparts friction to the vehicle wheel rim 900, and thereby causes (as a result) the vehicle 908 to consume more fuel in order to move (especially more so at highway speeds).

Referring to the embodiment depicted in FIG. 1D, the apparatus 100 includes a combination of a rim-cover assembly 102 and resilient clips 108.

The rim-cover assembly 102 has an outer peripheral edge 103. The rim-cover assembly 102 is configured (dimensioned) to cover, at least in part, the outer-facing zone 904 of the vehicle wheel rim 900. This is done for the case where the rim-cover assembly 102 is positioned relative to the outer-facing zone 904 of the vehicle wheel rim 900 (to do just so).

The resilient clips 108 are each positionable (locatable) at spaced-apart positions (along the elongated rod assembly 106). It will be appreciated that the spaced-apart positions are also located on the outer peripheral edge 103 of the rim-cover assembly 102 (as well). The resilient clips 108 are each configured to resiliently clip the outer peripheral edge 103 of the rim-cover assembly 102 at the spaced-apart positions to the outer peripheral rim edge 902 of the vehicle wheel rim 900. This is done for the case where the rim-cover assembly 102 is positioned relative to the outer-facing zone 904 of the vehicle wheel rim 900 just so (so that the resilient clips 108 may then be operatively installed accordingly).

In accordance with an embodiment, the vehicle 908 includes a car 910 (and any equivalent thereof). In accordance with another embodiment, the vehicle 908 includes a commercial trailer 912 (and any equivalent thereof). In accordance with an embodiment, the vehicle wheel rim 900 has an outer diameter (dimension) of about 22.5 inches. Therefore, the outer diameter of the outer peripheral rim edge 902 is about 22.5 inches.

Referring to the embodiment depicted in FIG. 1A to 1D, the rim-cover assembly 102 include a ridged material (such as a plastic molded material) of any suitable configuration, material composition, size, shape and/or dimension.

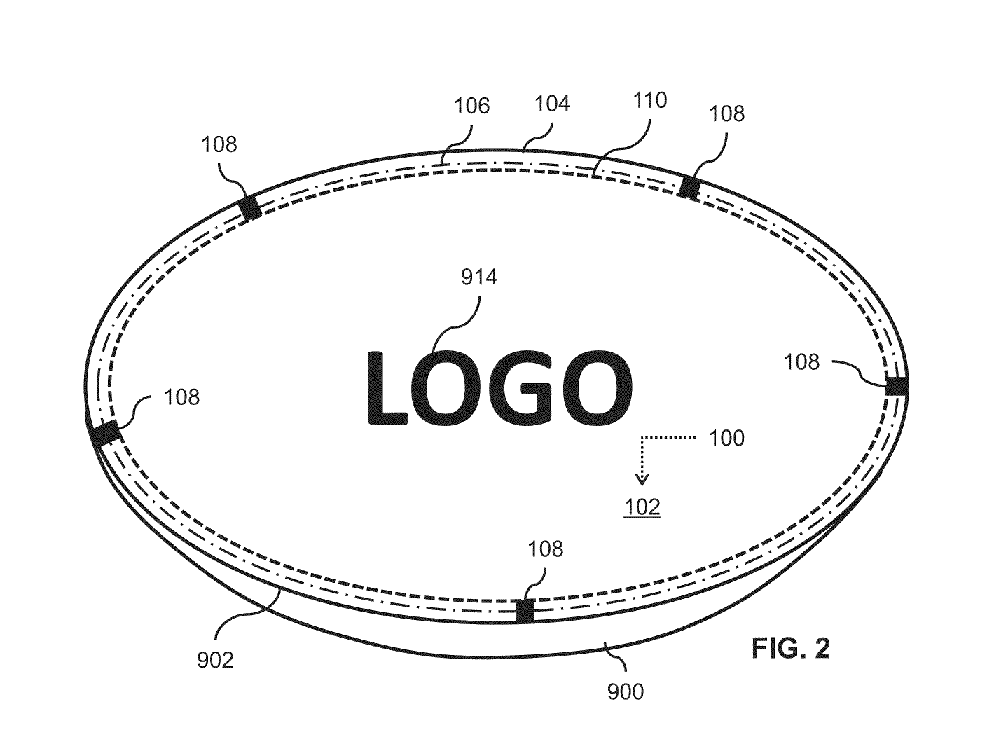

FIG. 2 depicts a view of an embodiment of the apparatus 100 of any one of FIGS. 1A, 1B, 1C and 1D. FIG. 2 depicts a perspective view. A partial view of the vehicle wheel rim 900 is depicted (to better illustrate the apparatus 100). For this view, the vehicle wheel rim 900 is cut in approximately half (along the radial axis extending from the vehicle wheel rim 900).

In accordance with the embodiment depicted in FIG. 2, the apparatus 100 includes a combination of a rim-cover assembly 102 an elongated rod assembly 106, and resilient clips 108. For the embodiment of FIG. 2, the rim-cover assembly 102 preferably includes a flexible material (such as a flexible fabric material), or may optionally include a ridged material (if desired).

The rim-cover assembly 102 has a peripheral sleeve 104 extending around the rim-cover assembly 102. The rim-cover assembly 102 is configured (dimensioned) to cover, at least in part, the outer-facing zone 904 of the vehicle wheel rim 900. This is done for the case where the rim-cover assembly 102 is positioned relative to the outer-facing zone 904 of the vehicle wheel rim 900 to do just so.

The elongated rod assembly 106 is configured to be (slidably) received, at least in part, in the peripheral sleeve 104 of the rim-cover assembly 102. The elongated rod assembly 106 has a length and a diameter.

Each of the resilient clips 108 are positionable at spaced-apart positions. The spaced-apart positions are located on the peripheral sleeve 104 of the rim-cover assembly 102. For the case where the rim-cover assembly 102 includes a flexible material, the resilient clips 108 are each configured to resiliently clip (A) the elongated rod assembly 106 (received in the peripheral sleeve 104) at the spaced-apart positions (positioned along the elongated rod assembly 106) to (B) the outer peripheral rim edge 902 of the vehicle wheel rim 900. This is done for the case where the elongated rod assembly 106 is received in the peripheral sleeve 104 and where the rim-cover assembly 102 is positioned relative to the outer-facing zone 904 of the vehicle wheel rim 900 just so. It will be appreciated that (in accordance with an option) the resilient clips 108 do not clip (in use) the peripheral sleeve 104 or the rim-cover assembly 102 to the outer peripheral rim edge 902 for the case where the rim-cover assembly 102 and/or the peripheral sleeve 104 includes a flexible material (such as a fabric or a cloth material).

Once the apparatus 100 is operatively mounted to the vehicle wheel rim 900, and the vehicle 908 is made to move, the technical effect of the apparatus 100 of FIG. 1D or FIG. 2 is to reduce, at least in part, air drag imparted to the vehicle wheel rim 900 by isolating, at least in part, air contact with the interior cavity formed by the vehicle wheel rim 900 (when the vehicle 908 is moving). In this manner fuel costs for operating the vehicle 908 may be reduced (at least in part), and/or vehicle maintenance may also be reduced (at least in part) since there may be less stress exerted to the vehicle 908.

In accordance with an embodiment, the rim-cover assembly 102 includes a flexible fabric material. In accordance with an embodiment, the rim-cover assembly 102 has a cover diameter configured to cover, at least in part, the interior cavity of the vehicle wheel rim 900 having an outer diameter dimension of about 22.5 inches. In accordance with an embodiment, the rim-cover assembly 102 is configured to receive a marking 914 (such as, a company logo or an advertising image).

In accordance with an embodiment, the peripheral sleeve 104 is fixedly connected to the rim-cover assembly 102. The peripheral sleeve 104 may be an extension of the rim-cover assembly 102. For instance, the peripheral sleeve 104 is sewn to the rim-cover assembly 102 along a sewing line 110 (by using a durable thread material). For instance, if the material of the peripheral sleeve 104 include a plastic material, the assembly may be heat formed (heat welded) to the rim-cover assembly 102 (if desired).

By way of example, the elongated rod assembly 106 may include a ring (a single ring) or ring portions that are not connected to each other. The ring portions, once operatively received in the peripheral sleeve 104, form a ring like structure similar to the single ring.

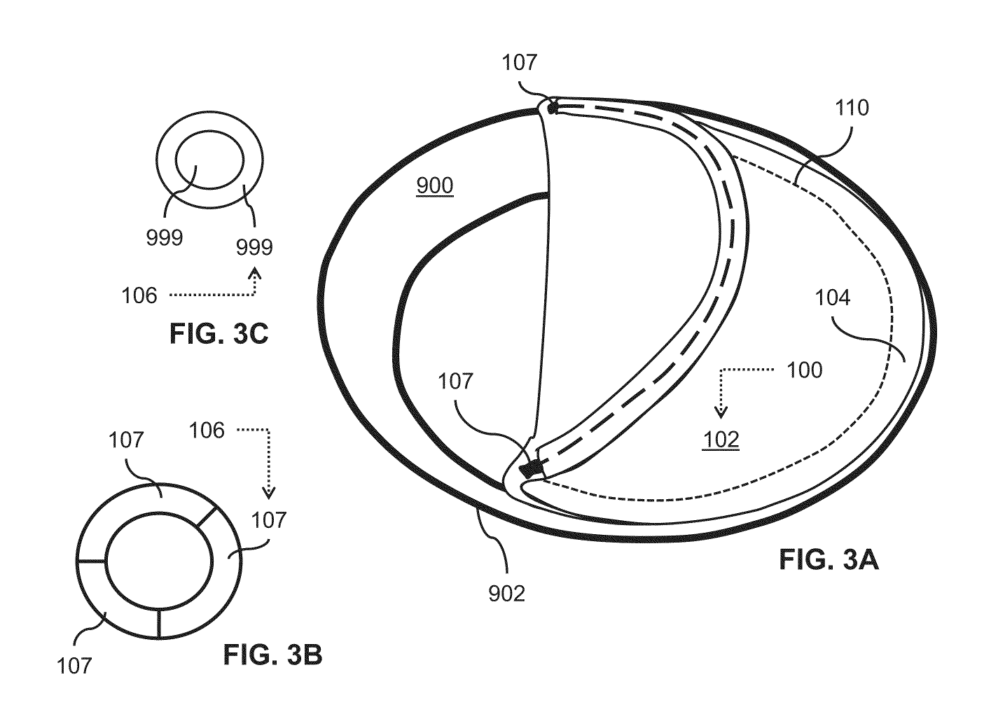

FIGS. 3A, 3B and 3C depict views of embodiments of an apparatus 100 of any one of FIGS. 1A, 1B, 1C and 1D. FIG. 3A depicts a perspective view (of the apparatus 100). FIG. 3B depicts a top view (of the elongated rod assembly 106). FIG. 3C depicts a cross-sectional view through the elongated rod assembly 106.

Referring to the embodiment depicted in FIG. 3A, the resilient clips 108 (depicted in FIG. 2) are removed from the rim-cover assembly 102, and this is so that the rim-cover assembly 102 is no longer fixedly connected (that is, is detached from) to the outer peripheral rim edge 902 of the vehicle wheel rim 900 (for description purposes).

Referring to the embodiment depicted in FIG. 3B, the elongated rod assembly 106 has a circular shape that conforms to (matches) the shape of the outer peripheral rim edge 902 (the inner diameter of the outer peripheral rim edge 902). The elongated rod assembly 106 includes elongated rod portions 107 that are positionable end to end with each other. Each of the elongated rod portions 107 has a circular cross-section and a length.

Referring to the embodiment depicted in FIG. 3A, the peripheral sleeve 104 is configured to be segmented into separate sleeve partitions. Each of the sleeve partitions is configured to receive a respective one of the elongated rod portions 107. As depicted in FIG. 3A, a selected one of the elongated rod portions 107 is folded over so that a section of the rim-cover assembly 102 (such as, about one third of the rim-cover assembly 102) is foldable (folded over, as depicted) once a selected on of the resilient clips 108 for the section of the rim-cover assembly 102 is removed. This is done in such a way that user-access to the interior cavity formed by the vehicle wheel rim 900 is user-accessible (for the user). This is done for the case where the user may need to access the interior of the vehicle wheel rim 900 for maintenance purposes, such as for accessing the tire valve (known and not depicted, etc.) positioned in the interior cavity of the vehicle wheel rim 900.

Referring to the embodiment depicted in FIG. 3C, the elongated rod assembly 106 includes an inner rod 116, and an outer layer 118 configured to encompass, at least in part, the inner rod 116. The inner rod 116 may include a solid material (such as, a metal alloy, stainless steel to avoid corrosion or rusting or a plastic material, etc.). The outer layer 118 may include a plastic material (such as, a plastic tube having about a 0.25 inch inner diameter, and defining an interior tube cavity configured to receive the inner rod 116 therein). The outer layer 118 may include a material that is sprayed onto the outer surface of the inner rod 116 (if so desired).

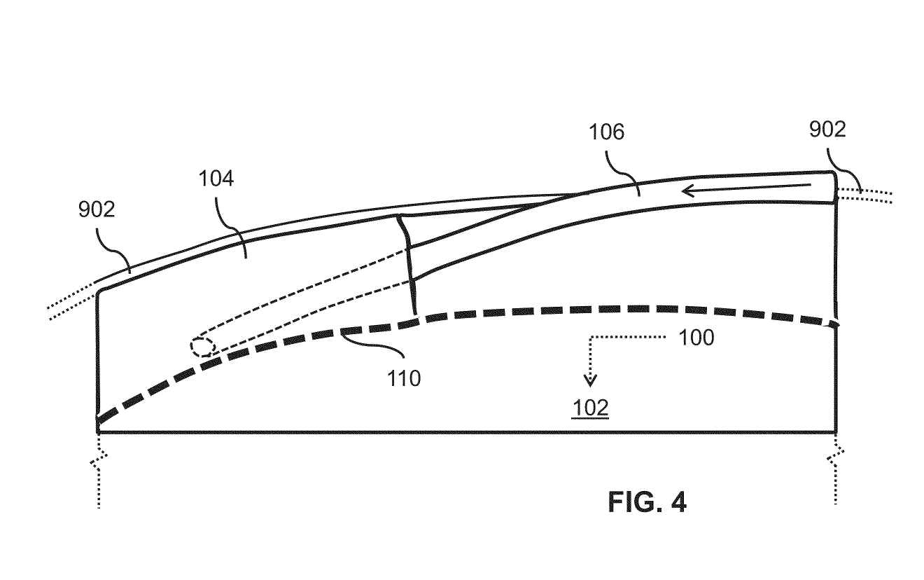

FIG. 4 depicts a view of an embodiment of an apparatus 100 of any one of FIGS. 1A, 1B, 1C and 1D. FIG. 4 depicts a perspective side view.

In accordance with the embodiment depicted in FIG. 4, the elongated rod assembly 106 is slidably received (at least in part) in the peripheral sleeve 104. Once the elongated rod assembly 106 is slidably received in the peripheral sleeve 104, the peripheral sleeve 104 may be closed shut (in a secure manner). It will be appreciated that a touch fastener (such as, the VELCRO (TRADEMARK) fastener) may be used to keep the peripheral sleeve 104 in a closed condition (if desired).

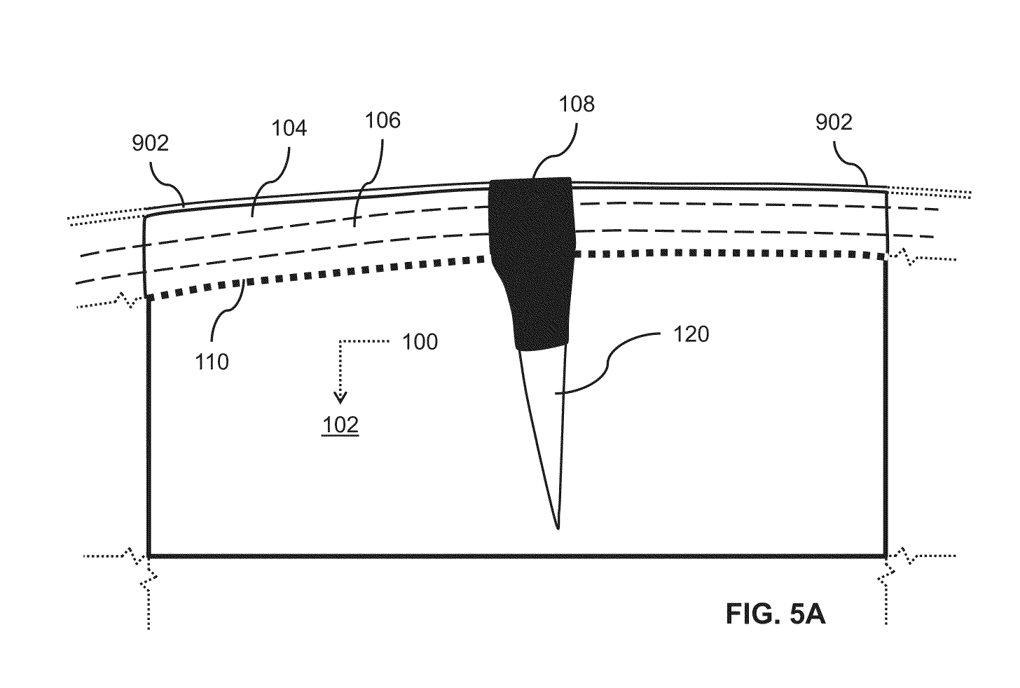

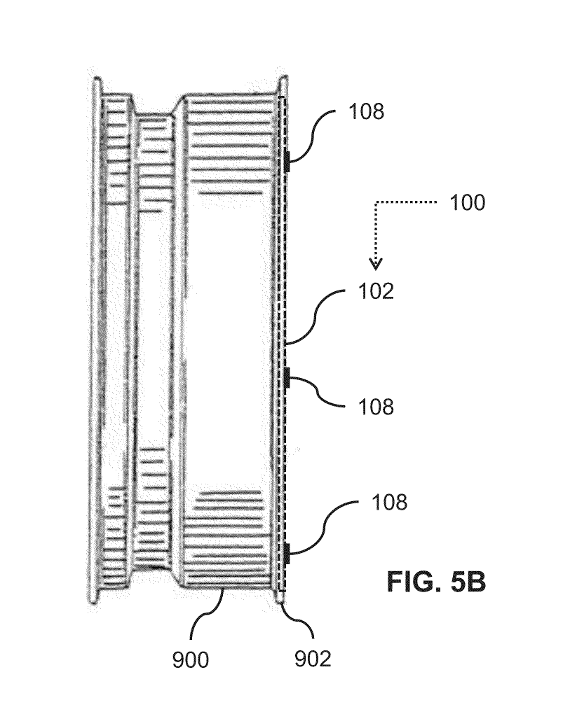

FIGS. 5A and 5B depict views of embodiments of an apparatus 100 of any one of FIGS. 1A, 1B, 1C and 1D. FIG. 5A depicts a perspective side view. FIG. 5B depicts a side view.

In accordance with the embodiment depicted in FIG. 5A, the resilient clips 108 are positioned to resiliently clip (snap fit) the elongated rod assembly 106 to the outer peripheral rim edge 902 of the vehicle wheel rim 900. Preferably, the resilient clips 108 are positioned to not resiliently clip (snap fit) a portion of the peripheral sleeve 104 to the outer peripheral rim edge 902 of the vehicle wheel rim 900 (for example, for the case where the material of the peripheral sleeve 104 includes a flexible fabric material).

The peripheral sleeve 104 defines eyelets 120 positioned along a length of the peripheral sleeve 104. The eyelets 120 are configured to expose the elongated rod assembly 106 that is received in the peripheral sleeve 104. A respective one of the eyelets 120 is provided for a respective one of the resilient clips 108 (in a corresponding relationship). Each of the eyelets 120 are spaced apart from each other along the peripheral sleeve 104. The resilient clips 108 are positioned in a respective one of the eyelets 120 in such a way that the resilient clips 108 may snap fit, in use, with the portion of the elongated rod assembly 106 that is exposed by the eyelets 120. In this manner, the resilient clips 108 are to be positioned to resiliently clip (snap fit) the elongated rod assembly 106 exposed by the eyelets 120 thereby allowing the resilient clips 108 to avoid clipping the peripheral sleeve 104 to the outer peripheral rim edge 902 of the vehicle wheel rim 900 (for the case where the rim-cover assembly 102 includes a flexible fabric). It is understood that the eyelets 120 are configured to expose, at least in part, a portion of the elongated rod assembly 106 for the case where the elongated rod assembly 106 is received into the peripheral sleeve 104 (for the case where the peripheral sleeve 104 and the rim-cover assembly 102 includes a flexible fabric material. The purpose of the eyelets 120 is to avoid using the resilient clips 108 to clip the fabric of the peripheral sleeve 104 and/or the rim-cover assembly 102 to the elongated rod assembly 106 and/or to the outer peripheral rim edge 902.

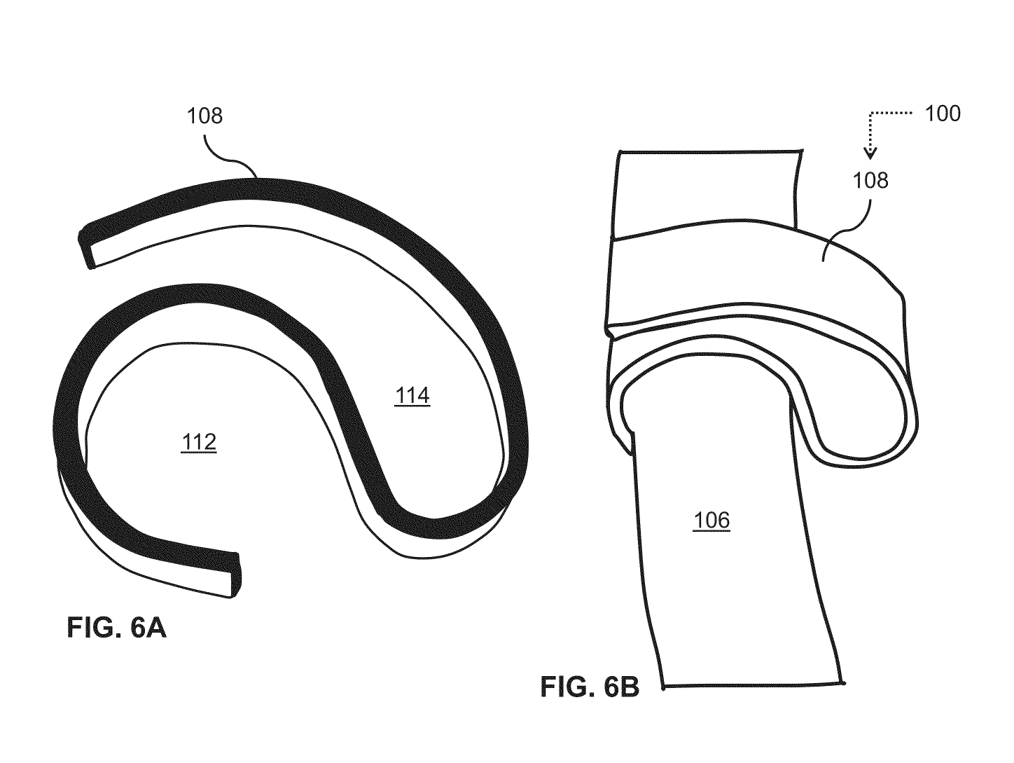

FIGS. 6A and 6B depict views of embodiments of an apparatus 100 of any one of FIGS. 1A, 1B, 1C and 1D. FIG. 6A depicts a side perspective view. FIG. 6B depicts a top perspective view.

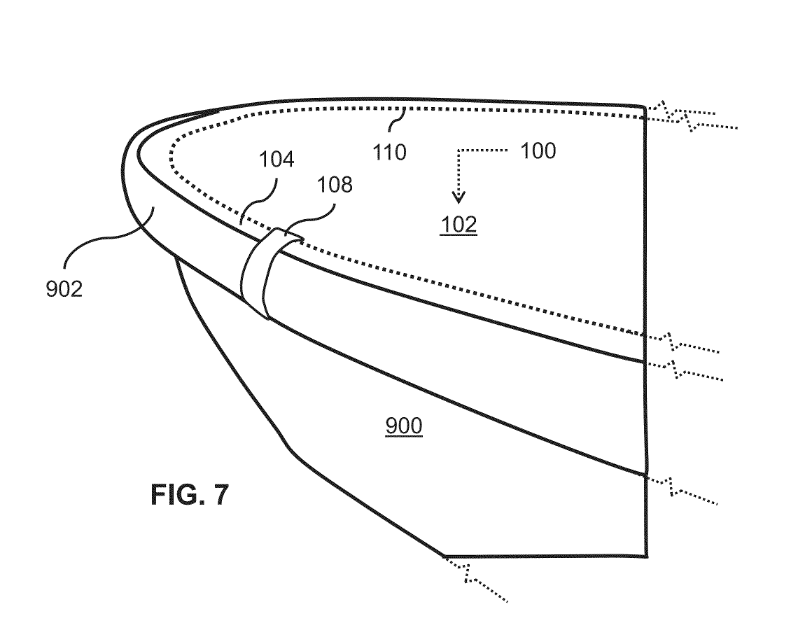

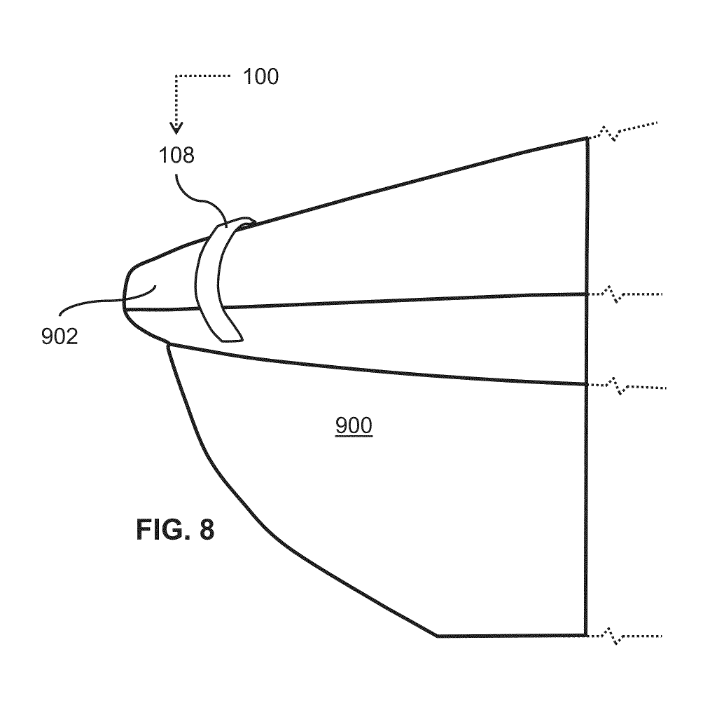

Referring to the embodiment depicted in FIG. 6, each of the resilient clips 108 defines (provides) a first clip zone 112 and a second clip zone 114. The first clip zone 112 is configured to snap fit (snap clip) with the elongated rod assembly 106 (as depicted in FIG. 6B). The second clip zone 114 is configured to snap fit (snap clip) with the outer peripheral rim edge 902 of the vehicle wheel rim 900 (as depicted in FIG. 7).

In accordance with an embodiment, each of the resilient clips 108 includes a spring body (such as, a resilient elastically deformable body). The resilient clips 108 each provides a serpentine shaped body. The resilient clips 108 each provides hooked ends that are spaced apart from each other and positioned on opposite sides of a serpentine shaped body.

Referring to the embodiment depicted in FIG. 6B, the resilient clips 108 are configured to snap (snap fit, snap click) with the elongated rod assembly 106. For instance, the resilient clips 108 may include a snap fastener (also called press stud, popper, or snap). The resilient clips 108 provides an interlocking structure.

FIG. 7 depicts a view of an embodiment of an apparatus 100 of any one of FIGS. 1A, 1B, 1C and 1D. FIG. 7 depicts a side perspective view.

Referring to the embodiment depicted in FIG. 7, the resilient clips 108 are configured to extend over the outer peripheral rim edge 902 of the vehicle wheel rim 900.

FIG. 8 depicts a view of an embodiment of an apparatus 100 of any one of FIGS. 1A, 1B, 1C and 1D. FIG. 8 depicts a side perspective view.

Referring to the embodiment depicted in FIG. 8, the resilient clips 108 are configured to extend over the outer peripheral rim edge 902 of the vehicle wheel rim 900 to a location underneath (at least in part) the outer peripheral rim edge 902.

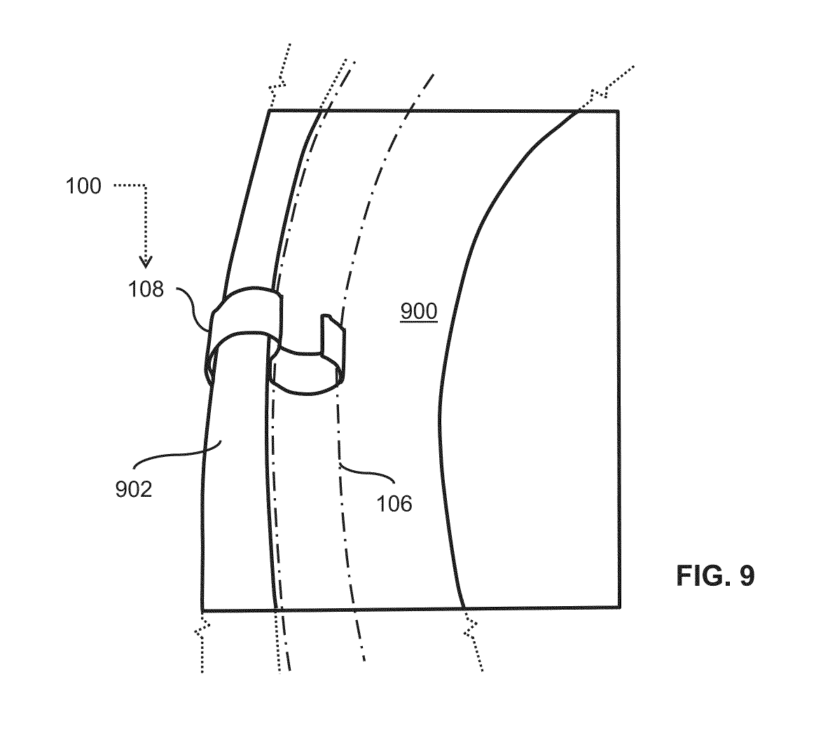

FIG. 9 depicts a view of an embodiment of an apparatus 100 of any one of FIGS. 1A, 1B, 1C and 1D. FIG. 9 depicts a side perspective view from inside the interior cavity formed by the vehicle wheel rim 900.

Referring to the embodiment depicted in FIG. 9, the resilient clips 108 are configured to extend over the opposite sides of the outer peripheral rim edge 902 of the vehicle wheel rim 900.

This written description uses examples to disclose the invention, including the best mode, and also to enable any person skilled in the art to make and use the invention. The patentable scope of the invention is defined by the claims, and may include other examples that occur to those skilled in the art. Such other examples are within the scope of the claims if they have structural elements that do not differ from the literal language of the claims, or if they include equivalent structural elements with insubstantial differences from the literal language of the claims.

It may be appreciated that the assemblies and modules described above may be connected with each other as required to perform desired functions and tasks within the scope of persons of skill in the art to make such combinations and permutations without having to describe each and every one in explicit terms. There is no particular assembly or component that may be superior to any of the equivalents available to the person skilled in art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted). It is understood, for this document, that the phrase “includes” is equivalent to the word “comprising.” The foregoing has outlined the non-limiting embodiments (examples). The description is made for particular non-limiting embodiments (examples). It is understood that the non-limiting embodiments are merely illustrative as examples.

What is claimed is:

1. An apparatus for a vehicle wheel rim having an outer peripheral rim edge surrounding an outer-facing zone, the vehicle wheel rim configured to provide a connection with a vehicle tire of a vehicle, the apparatus comprising:
a rim-cover assembly having an outer peripheral edge, and being configured to cover, at least in part, the outer-facing zone of the vehicle wheel rim for the case where the rim-cover assembly is positioned relative to the outer-facing zone of the vehicle wheel rim to do just so; and
resilient clips each being positionable at spaced-apart positions being located on the outer peripheral edge of the rim-cover assembly, and the resilient clips being configured to resiliently clip the outer peripheral edge of the rim-cover assembly at the spaced-apart positions to the outer peripheral rim edge of the vehicle wheel rim, for the case where the rim-cover assembly is positioned relative to the outer-facing zone of the vehicle wheel rim just so.

2. An apparatus for a vehicle wheel rim having an outer peripheral rim edge surrounding an outer-facing zone, the vehicle wheel rim configured to provide a connection with a vehicle tire of a vehicle, the apparatus comprising:
a rim-cover assembly having a peripheral sleeve extending around the rim-cover assembly, and the rim-cover assembly being configured to cover, at least in part, the outer-facing zone of the vehicle wheel rim for the case where the rim-cover assembly is positioned relative to the outer-facing zone of the vehicle wheel rim to do just so; and
an elongated rod assembly being configured to be received, at least in part, in the peripheral sleeve of the rim-cover assembly; and
resilient clips each being positionable at spaced-apart positions being located on the peripheral sleeve of the rim-cover assembly, and the resilient clips being configured to resiliently clip the elongated rod assembly at the spaced-apart positions to the outer peripheral rim edge of the vehicle wheel rim, for the case where the elongated rod assembly is received in the peripheral sleeve and where the rim-cover assembly is positioned relative to the outer-facing zone of the vehicle wheel rim just so.

3. The apparatus of claim 2, wherein:
the rim-cover assembly has a cover diameter configured to cover the vehicle wheel rim having a diameter of about 22.5 inches.

4. The apparatus of claim 2, wherein:
the rim-cover assembly is configured to receive a marking.

5. The apparatus of claim 2, wherein:
the outer peripheral rim edge of the vehicle wheel rim has an outer diameter of about 22.5 inches.

6. The apparatus of claim 2, wherein:
the vehicle includes a car.

7. The apparatus of claim 2, wherein:
the vehicle includes a commercial trailer.

8. The apparatus of claim 2, wherein:
the resilient clips do not clip, in use, the peripheral sleeve and the rim-cover assembly to the outer peripheral rim edge for the case where the rim-cover assembly and the peripheral sleeve includes a flexible material.

9. The apparatus of claim 2, wherein:
the elongated rod assembly includes ring portions that are not connected to each other, and the ring portions, once operatively received in the peripheral sleeve, form a ring like structure.

10. The apparatus of claim 2, wherein:
the elongated rod assembly has a circular shape that conforms to a shape of the outer peripheral rim edge.

11. The apparatus of claim 2, wherein:
the elongated rod assembly includes elongated rod portions that are positionable end to end with each other.

12. The apparatus of claim 11, wherein:
the peripheral sleeve is configured to be segmented into separate sleeve partitions, and each of the sleeve partitions is configured to receive a respective one of the elongated rod portions.

13. The apparatus of claim 11, wherein:
a selected one of the elongated rod portions is folded over so that a section of the rim-cover assembly is foldable once a selected on of the resilient clips for the section of the rim-cover assembly is removed, in such a way that user-access to an interior cavity formed by the vehicle wheel rim is user accessible.

14. The apparatus of claim 2, wherein:
the elongated rod assembly includes:
an inner rod; and
an outer layer configured to encompass, at least in part, the inner rod.

15. The apparatus of claim 2, wherein:
the peripheral sleeve defines eyelets positioned along a length of the peripheral sleeve,
each of the eyelets are spaced apart from each other along the peripheral sleeve,
the eyelets are configured to expose the elongated rod assembly that is received in the peripheral sleeve,
a respective one of the eyelets is provided for a respective one of the resilient clips in a corresponding relationship, and
the resilient clips are positioned in a respective one of the eyelets in such a way that the resilient clips snap fit, in use, with a portion of the elongated rod assembly that is exposed by the eyelets.

16. The apparatus of claim 2, wherein:
each of the resilient clips provides:
a first clip zone configured to snap fit with the elongated rod assembly; and
a second clip zone configured to snap fit with the outer peripheral rim edge of the vehicle wheel rim.

17. The apparatus of claim 2, wherein:
each of the resilient clips provides a serpentine shaped body.

18. The apparatus of claim 2, wherein:
each of the resilient clips provides hooked ends that are spaced apart from each other and positioned on opposite sides of a serpentine shaped body.

19. The apparatus of claim 2, wherein:
the resilient clips are configured to extend over the outer peripheral rim edge of the vehicle wheel rim.

20. The apparatus of claim 2, wherein:
the resilient clips are configured to extend over the outer peripheral rim edge of the vehicle wheel rim to a location underneath, at least in part, the outer peripheral rim edge; and
the resilient clips are configured to extend over opposite sides of the outer peripheral rim edge of the vehicle wheel rim.
